(19) United States
(12) Patent Application Publication
(10) Pub. No.: US 2004/0095844 A1
(43) Pub. Date: May 20, 2004

(54) Enclosed implantable material mixing system

(76) Inventors: Scott H. Miller, Sunnyvale, CA (US); Bryan Michael Barr, San Jose, CA (US)

Correspondence Address: BOZICEVIC, FIELD & FRANCIS LLP, 200 MIDDLEFIELD RD, SUITE 200, MENLO PARK, CA, 94025, US

(21) Appl. No.: 10/703,738

(22) Filed: Nov. 6, 2003

Related U.S. Application Data
(63) Continuation of application No. 09/793,842, filed on Feb. 26, 2001, now abandoned.

(51) Int. Cl. B01F 1/00; B65D 25/08; B65D 71/00; B65D 69/00

(52) U.S. Cl. 366/130; 206/220; 206/568; 206/570

(57) ABSTRACT

An enclosed implantable material mixing system is described herein. The system uses an enclosable vial or container into which bone cement mixture may be mixed by agitation. The bone cement mixture may be made of a combination of polymer and liquid monomer, but because of the method of agitation, e.g., shaking the vial and its contents, the ratio of the monomer-to-polymer is critical. A desirable weight ratio of the monomer-to-polymer is about 0.3 to about 1, and more preferably about 0.53 to about 0.63, and is more preferably about 0.57. The vial or container may also include a free-floating, or disassociated, agitator to aid with the mixing process. To prepare the composition, the vial and its contents may be capped and shaken until the mixture dissolves completely. The contents of the vial are then allowed to sit and undergo a solvation process at the end of which the mixture may be shaken again and then poured out for use.

### FIELD OF THE INVENTION

The invention relates to compositions for use as tissue implants, preferably hard tissue implants. More particularly, this invention relates to components used in mixing the compositions and to the methods for mixing them, as well as the particular ratios in which materials used in the compositions are combined.

### BACKGROUND OF THE INVENTION

Materials used for implanting prosthetic devices into live bone are usually made from a fine cement powder, typically polymethyl methacrylate (PMMA), mixed with a monomer liquid, typically methyl methacrylate (MMA), to form a flowable implant mixture. Physical mixing of the dry cement powder and liquid is required in order to make a flowable mixture. The mixture usually requires a sitting time to allow the mixture to solvate completely after mixing. It is not sufficient to merely bring the liquid into contact with the cement powder because the liquid will not flow throughout the powder uniformly. Also, during mixing the monomer liquid should be distributed equally throughout the mixture so that the mixture is uniform. Improperly mixing the liquid and powder together may result in products of the mixture having undesirable properties. For instance, a mixture having an excess amount of monomer liquid may be runny which leaves the mixed bone cement less viscous than required and the mixture may also include pockets of unwetted dry powder. Where there is an excess of powder, the resulting mixture may be more viscous than required and may also contain regions where there is no monomer liquid.

Bone cement is conventionally mixed in an open bowl with a spatula or in an application-specific mixer. An example of such a mixer is shown and described in U.S. Pat. No. 6,116,773 to Murray, the entirety of which is incorporated herein by reference.

The dry powdered bone cement is usually compacted in a package and when opened and poured, the fine particles of the bone cement may expand or fluff to increase the volume appreciably. However, in pouring the cement powder, it is very difficult to avoid generating a cloud of the abrasive powder dust which can settle on nearby instruments and materials. The powder, when on the floor, can also create a slippery safety hazard.

Prior to mixing, bone cement powder may typically be poured into an empty mixing chamber and monomer liquid may be poured into the chamber on top of the powder. Alternatively, the monomer liquid may be poured into the mixing chamber before bone cement powder is poured into the chamber. When several doses of bone cement are mixed, the powder and monomer liquid may be poured into the mixer alternately. However, such a method of mixing may introduce and trap air between particles of the bone cement powder, which in turn may form air inclusions in the mixture.

After the bone cement powder and liquid are poured into the mixing chamber, the ingredients are physically mixed together typically by moving a stirrer in the mixing chamber. However, with such a method, it can be difficult to produce a uniform distribution of monomer liquid along the height of the body of the mixture. When mixing is complete, the stirrer is usually withdrawn from the cement. Some of the mixture which adheres to the withdrawn stirrer will be wasted and the stirrer may also leave recesses in the mixture, possibly forming air inclusions.

During injection or otherwise implanting of the bone implant material, fluoroscopic imaging, magnetic resonance imaging (MRI), or computed tomography (CT), or another imaging technique may be used to track the path that the bone implant material takes as well as its final position upon implantation. Contrast agents such as barium sulfate powder may be used to aid the visibility of the bone implant material by imaging. The barium sulfate powders and other contrast agents presently used are generally very fine. Still, such radio-opaque substances, like barium sulfate, often sink in the mixture during the mixing procedure and are not uniformly distributed throughout. Then the barium may be left behind in the mixing chamber or bowl when pouring the mixture out into a reservoir or cartridge for implantation.

Moreover, the fumes generated by bone cement mixtures are generally considered obnoxious, unpleasant, and even noxious. Overexposure to the fumes may have effects such as irritation to the eyes, nose, and throat, headaches, nausea, dizziness, fatigue, and weakness in the arms and legs. Inhalation of the fumes may even cause narcosis. Also, because of the many problems associated with conventional methods of mixing, such methods are considered difficult to repeat accurately due to the variability in the resulting viscosity of the bone cement.

Accordingly, there is a need for the present system which alleviates or eliminates many of these concerns.

### SUMMARY OF THE INVENTION

An enclosed mixing system for hard tissue implant material is described herein. The system uses an enclosable vial or container into which bone cement mixture may be mixed by agitation. The cement mixture, which is made of a combination of polymer and liquid monomer, may also include particles for medical imaging, e.g., tracers and grayscale elements. Because of the method of agitation in this system, i.e., shaking the vial and its contents, the ratio of the monomer-to-polymer is critical. An amount of the polymer and contrast agent may be included within the vial. Into this mixture, an amount of liquid monomer may be added by a variety of methods provided that the proper ratio of monomer-to-polymer is maintained. A desirable weight ratio of the monomer-to-polymer is between about 0.3 to about 1, and is preferably between about 0.53 to about 0.63, and is more preferably at about 0.57. These ranges, as mentioned above, are critical to the present invention because a mixture within these ratios is able to be uniformly mixed via the system of agitation, i.e., shaking, which is disclosed herein. The resulting viscosity of the mixture is ideally suited for injection into the patient via a syringe. Outside these ranges, proper mixing fails to occur.

Although not necessary, the vial or container may also include a free-floating, or disassociated, agitator. The agitator may be a non-corrosive element of any shape. Preferably it is of a size and shape to inhibit its removal from the vial. Alternatively, a magnet may be used to magnetically restrain a ferrous agitator while the contents of the vial are poured out after mixing.

After the combination of materials are introduced into the vial, the vial may then be capped and shaken or agitated until the mixture dissolves completely. After the shaking procedure, the vial is preferably allowed to sit to undergo a solvation process where the viscosity of the mixture builds. Following this solvation, the mixture may then be shaken again and then poured out for use. The second shaking procedure may be used to ensure uniformity of the mixture prior to it being poured out.

The components used for mixing, the methods for mixing the materials, as well as the particular ratios of the materials being combined are all considered to be part of the present invention.

### BRIEF DESCRIPTION OF THE DRAWINGS

Each of the following figures diagrammatically illustrates aspects of the present invention. The illustrations provide examples of the invention described herein.

FIG. 1 shows a mixer vial with an optional agitator and magnet.

FIG. 2 shows the mixer assembly with the agitator being mixed.

FIG. 3 shows the contents of the mixer assembly being poured out with the agitator being magnetically restrained.

FIGS. 4A and 4B show a variation on a perforated cap having a removable peel tab.

FIGS. 5A and 5B show an alternative variation on a prescored cap having a depressible tab.

FIGS. 6A and 6B show another variation on a prescored cap having a lifting tab.

FIG. 7 shows an alternative double-cap design.

FIG. 8 shows a variation on a kit with a syringe which may be used as part of the mixing system.

### DETAILED DESCRIPTION OF THE INVENTION

The enclosed implantable material mixing system disclosed herein may be used for a variety of applications. Using the present system and methods, accurately repeating mixture results and obtaining uniform consistency is possible.

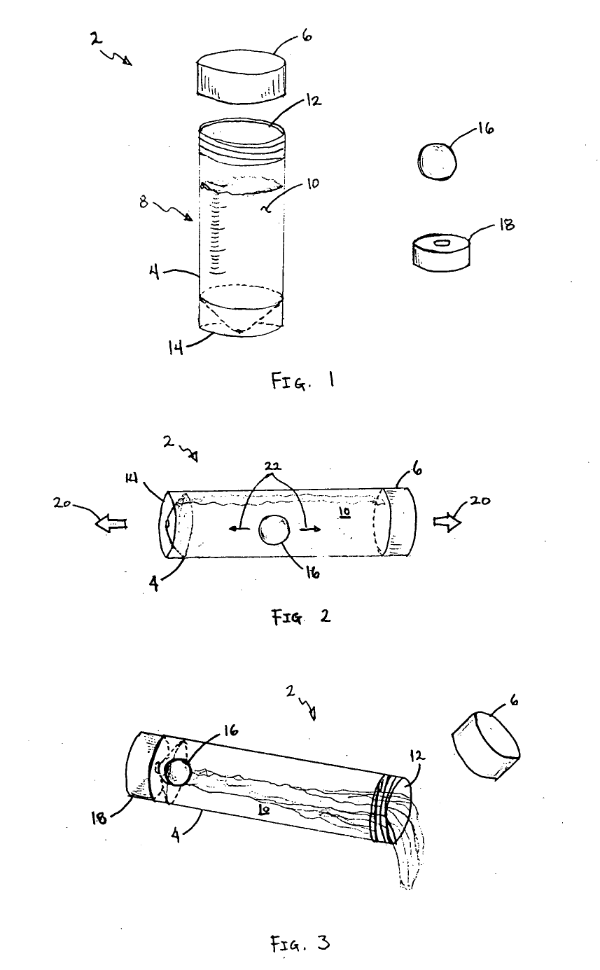

FIG. 1 shows a typical mixer vial assembly 2 which may comprise vial 4 and cap 6. Cap 6 may be any variety of cap, e.g., screw-on, press-on, removable lid, etc. Vial 4 may also be any variety of conventional vial, provided it is of an appropriate size and volume to allow mixing as disclosed herein, and is preferably graduated 8 to allow for volume verification during use. In one variation, assembly 2 may also include agitator 16 and magnet 18, the use of each being described below.

Within vial 4, a pre-measured contrast agent, e.g., a barium sulfate (BaSO₄) mixture, may be included. The contrast agent may typically comprise an amount of tracer and grayscale particles, with the tracer particles comprising preferably less than about 10% wt. of the resulting cement mixture 10, and is useful in providing the physician a reference for directional motion of the bone cement under observation by, e.g., a fluoroscope, MRI, CT, during implantation within a patient. The contrast agent may alternatively be a liquid. The grayscale particles may be comprised of almost any suitable radio-opaque material, e.g., tantalum, TiO₂, barium, etc. The tracer particles in the contrast agent may be preferably premixed with a grayscale medium, usually between about 10% wt and about 50% wt. of the resulting cement mixture 10, and is useful in providing a grayscale contrast under the fluoroscope for the mixture during implantation. The contrast agent is inert relative to the cement mixture 10. Although having too much of the tracer particles may weaken the cement mixture 10. A preferable contrast agent is described in U.S. patent application Ser. No. 08/950,256, entitled “Enhanced Visibility Materials For Implantation In Hard Tissue”, which is incorporated herein by reference in its entirety.

To this contrast agent in vial 4, polymer, e.g., polymethyl methacrylate (PMMA) or polymethyl methacrylate/styrene copolymer, may be added in a predetermined amount by a physician, nurse, or technician for mixing and preparing the mixture 10 prior to implantation. The predetermined amount of polymer may also be prepackaged to be included within vial 4 premixed with the contrast agent. Gradations 8 on vial 4 are also useful in allowing verification of the volume of polymer and contrast agent.

Prior to adding the monomer, e.g., methyl methacrylate (MMA), an agitator 16, may be added to the polymer and contrast agent. Agitator 16 may be used to ensure that the mixture 10 properly combines in a uniform state to form a material suitable for implantation by agitating the various ingredients. Although it is preferable to omit agitator 16 entirely, FIG. 2 shows agitator 16 included in mixture 10 in one variation. Agitator 16 may be made of any variety of materials that are chemically compatible with the monomer, biocompatible, and preferably denser than mixture 10. Agitator 16 is preferably metallic, or ferrous, to allow use with magnet 18. It is also small enough to fit entirely through opening 12 and into vial 4 with enough space to move about uninhibited as it is unconnected to any external mechanism or device. Agitator 16 may be a non-corrosive agitator, e.g., stainless steel ball bearing, as shown in FIGS. 1-3, a plastic-coated steel ball bearing, or even a biocompatible milling media. Aside from material, it may also comprise any number of shapes which inhibit agitator 16 from rolling or flowing out of vial 4 through opening 12 after mixing when cement 10 is being removed or poured out. Such shapes may include, e.g., cones, double-cones, disks, pyramids, cylinders, cubes, and parallelepipeds.

Once the polymer, and if desired agitator 16, are added to vial 4, the liquid monomer, e.g., MMA, may then be added. The monomer may be added by a variety of methods. One such method may be to inject the monomer via a large gauge syringe directly into the polymer. Alternatively, the monomer may be injected with the syringe from the bottom of the vial to the top to ensure that several cubic centimeters of monomer were dispensed at both the top and bottom of the mixture. Cap 6 may then be replaced to cover opening 12.

Mixture 10 may then be mixed by shaking assembly 2, as shown in FIG. 2, preferably as indicated by arrows 20. As seen, if agitator 16 is included, it will also move as indicated by arrows 22 to aid in the mixing process.

When combining the liquid monomer with the polymer, the ranges of acceptable amounts and the ratios by which they are combined are critical to the present invention, especially because of the method of shaking and/or agitating the mixture. For instance, if too little monomer is added, the shaking procedure will not combine the ingredients properly, thus resulting in an unacceptable mixture similar to wet sand, i.e., there may be pockets of unwetted material. Likewise, if too much monomer is added, the shaking procedure will also not work because the resulting mixture may be runny which leaves the mixed bone cement less viscous than required and the mixture may also include pockets of unwetted dry powder. Having too much monomer would also allow the tracers to settle. Therefore, it is critical that a specific range be met for a mixture to be combined via shaking.

Accordingly, a specific range of acceptable amounts and ratios for combining the monomer and polymer exists. The desired weight ratio of monomer-to-polymer may range from about 0.3 to about 1, and preferably from about 0.53 to about 0.63 to yield desirable results. The ratio is more preferably about 0.57. This range of ratios are applicable to the bone cement, Secour Acrylic Resin, manufactured by Parallax Medical, Inc. These ratios are applicable to other commercially available bone cements. Results for cement mixture 10 are considered desirable when the viscosity is such that it is easily injectable into, e.g., bone, with a uniform mixture and with no air-inclusions. Moreover, the size and volume of vial 4 is not a limiting factor. Vial 4 may be scaled to any necessary size vial or container, provided that there is sufficient space left over within the vial once cement mixture 10 has been added to allow enough room to mix and shake the mixture 10.

After shaking or mixing assembly 2 to ensure adequate mixing of mixture 10, vial 4 may be allowed to sit to allow for the even dispension of the barium within the cement. During this solvation time, the viscosity of mixture 10 increases; it may therefore be advantageous to leave vial 4 on its side. Doing so may prevent the barium from sinking to bottom end 14 of vial 4 since the barium may settle during the solvation time. After expiration of the solvation time, which may range from about 30 seconds to several minutes, e.g., about 5 minutes, vial assembly 2 may be shaken again, as in FIG. 2, prior to dispensing to ensure uniformity.

During the dispensing procedure, cap 6 may simply be removed and the cement mixture 10 may be poured out through opening 12, as shown in FIG. 3. However, if agitator 16 were included, it may be desirable to restrain it to prevent it from flowing out with mixture 10 into a reservoir. Magnet 18 may be used for this purpose by holding it against bottom end 14 or along the sides of vial 4 to attract and magnetically hold agitator 16. Other methods of retaining agitator 16 within vial 4 may include having the agitator in different shapes which inhibit its removal, as discussed above. This may be especially useful if the agitator were made of a nonmetallic material, e.g., aluminum oxide or other biocompatible material, when use of magnet 18 would not magnetically attract the agitator. Alternatively, vial 4 itself may be configured to allow mixture 10 to pass yet retain agitator 16 within the container.

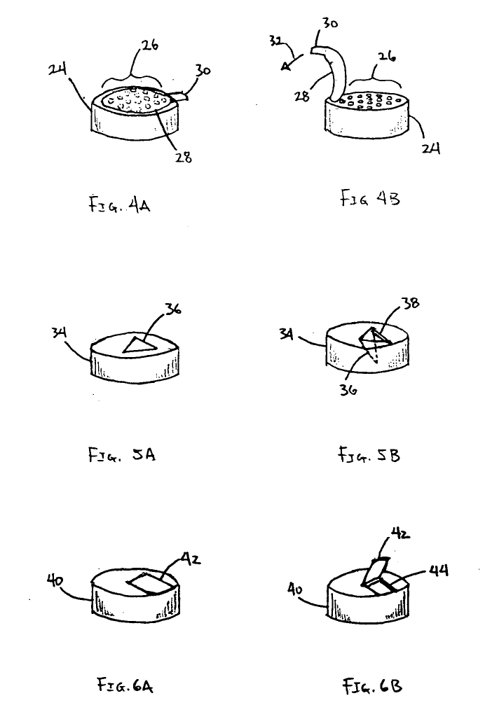

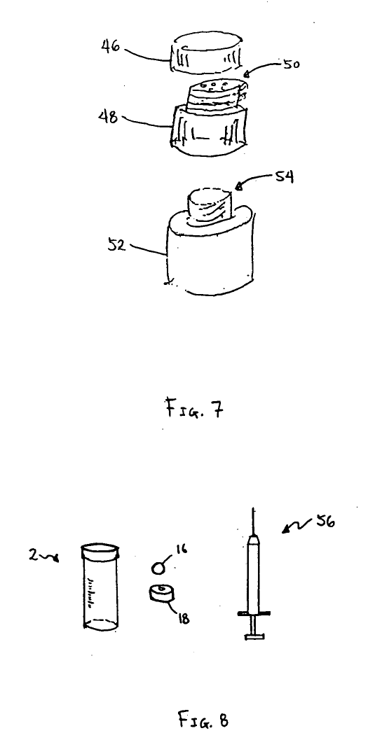

FIGS. 4A through 6B show alternative cap designs which avoid having to remove the cap from vial 4 to dispense mixture 10 and thereby prevent an agitator from exiting vial 4. FIGS. 4A and 4B show an alternative cap 24 which has perforations 26 throughout its top. Perforations 26 may be covered by pull tab 28, which may subsequently be removed after the shaking and mixing procedure by pulling on tab 30 in the direction of arrow 32, thereby exposing perforations 26 and allowing mixture 10 to exit. Another design is shown in FIGS. 5A and 5B. Here, cap 34 may have a prescored tab 36 or shape which may either be removed entirely by a pull tab, or by pushing downward on prescored tab 36 to create opening 38. If pushed downward, prescored tab 36 is preferably retained by at least one edge to prevent tab 36 from falling into mixture 10. Opening 38 is also preferably a size sufficient to allow cement mixture 10 to exit but not the agitator. Also shown is another variation for cap 40 in FIGS. 6A and 6B. Tab 42 may be of a design which allows the tab 42 to be pulled outward while being retained by at least one edge to create opening 44. The various caps and lids are presented for exemplary purposes and the present invention is obviously not limited by cap design. The designs of the cap is meant to encompass various methods of exiting a mixture while retaining an agitator.

FIG. 7 shows an alternative double-cap variation combining the cap and agitator-retaining features discussed above. Upper cap 46 is a cap which may be placed and fastened over lower cap 48 by any variety of methods discussed herein. Lower cap 48 may itself be a cap which is placed and fastened onto vial 52 to cover opening 54. Lower cap 48 is shown with perforations 50 in the figure, but lower cap 48 may comprise any of the agitator-retaining features as discussed above for the various cap designs. When pouring out the mixture, upper cap 46 may be removed while leaving lower cap 48 attached to vial 52, thereby covering opening 54 to retain the agitator yet allow the mixture to pass through.

FIG. 8 shows the vial 2, agitator 16, and magnet 18 of FIG. 1, with syringe 56 as an optional part of the mixing system. Syringe 56 may be used to deliver the liquid monomer by injection into the polymer for mixture as described herein. Syringe 56 may be included in a kit with a variety of any of the other devices described herein. Syringe 56 may be used with a variety of needles having different gauges, e.g., 18 gauge, 16 gauge, 14 gauge, etc.

The components and ratioed amounts of materials may be variously packaged to provide the physician, nurse, or technician a complete kit for particular uses. Additionally, a description providing instructions-for-use may also be included which provides methods and instructions for preparations of the cement mixture as described herein.

### EXAMPLE

An illustrative experiment is described in the following. An amount of barium sulfate, BaSO₄, which included tracer material, about 0.5 g, mixed with grayscale material, about 4.5 g, was mixed and placed in a Sarstedt vial (polypropylene vial with a polyethylene cap) having a 30 ml capacity. The grayscale-to-tracer ratio was about 9.0 for this experiment.

A volume of PMMA powder was added into this vial until about 20 ml was reached. About 8.5 cm³ of a monomer liquid containing 0.5% vol./vol. dimethylperatoluene (DMPT) was then added to this barium-polymer mixture. An agitator element was also added to the mixture along with the monomer liquid.

The vial was then capped and shaken, as in FIG. 2, for approximately 1 min. The vial was then allowed to remain undisturbed during a solvation time of about 3 min. At the end of the solvation time, the vial and contents were shaken again and then poured into a reservoir, e.g., a cup or bowl, to allow observation for setting, evenness (uniformity), barium dispension, pourability, dry residuals, etc.

The results of the experiment showed that the cement barium mixture was evenly mixed and set like normally mixed mixtures. Although the barium did not initially go into solution, continued shaking for about 30 to 40 seconds blended the mixture uniformly. Moreover, continued agitation successfully yielded desirable results with very little barium being settled out or left behind in the vial. Furthermore, no obnoxious fumes were released during the mixing and the monomer liquid did not evaporate during mixture.

It is noted that this invention has been described and specific examples or variations of the invention have been portrayed. The use of those specific examples is not intended to limit the invention in any way. Additionally, to the extent that there are variations of the invention which are within the spirit of the disclosure and are equivalent to features found in the claims, it is the intent that the claims cover those variations as well. All equivalents are considered to be within the scope of the claimed invention, even those which may not have been set forth herein merely for the sake of brevity. Furthermore, it is contemplated that each and every optional feature of the inventive variations described herein may be specifically excluded from the invention claimed and be so-described as a negative limitation. Also, the various aspects of the invention described herein, in any manner, may be modified and/or used in combination with such other aspects also described to be part of the invention either explicitly, implicitly or inherently in order to form variations considered to be part of the invention.

We claim:

1. An implantable cement mixing system for mixing via agitation in an enclosable container, comprising a liquid monomer and a polymer to be combined in a monomer-to-polymer ratio of about 0.3 to about 1 by weight.

2. The system of claim 1 wherein the monomer-to-polymer ratio is about 0.53 to about 0.63 by weight.

3. The system of claim 1 wherein the monomer-to-polymer ratio is about 0.57 by weight.

4. The system of claim 1 wherein the liquid monomer comprises methyl methacrylate.

5. The system of claim 1 wherein the polymer is a powder selected from the group consisting of polymethyl methacrylate and polymethyl methacrylate/styrene copolymers.

6. The system of claim 1 wherein the system further comprises radio-opaque particles.

7. The system of claim 6 wherein the radio-opaque particles comprise barium sulfate.

8. The system of claim 6 wherein the radio-opaque particles comprise tracer particles and grayscale particles.

9. The system of claim 8 wherein the grayscale particles comprise about 10% to about 50% by weight.

10. The system of claim 8 wherein the grayscale particles are selected from the group consisting of tantalum, TiO₂, and barium.

11. The system of claim 8 wherein the tracer particles comprise less than about 10% by weight.

12. The system of claim 8 wherein the grayscale-to-tracer ratio is about 9 by weight.

13. The system of claim 1 further comprising an enclosable container.

14. The system of claim 13 further comprising a disassociated agitator configured to fit entirely within the container.

15. The system of claim 14 wherein the agitator is chemically compatible with the liquid monomer and the polymer.

16. The system of claim 14 wherein the agitator is metallic.

17. The system of claim 16 further comprising a magnet for attracting the agitator.

18. The system of claim 14 wherein the agitator is selected from the group consisting of stainless steel ball bearings, plastic-coated steel ball bearings, and biocompatible milling media.

19. The system of claim 14 wherein the agitator comprises a shape specially adapted to inhibit removal from the container.

20. The system of claim 19 wherein the shape is selected from the group consisting of cones, double-cones, disks, pyramids, cylinders, cubes, and parallelepipeds.

21. The system of claim 13 wherein the system comprises a cap for the enclosable container.

22. The system of claim 21 wherein the cap defines a plurality of perforations.

23. The system of claim 22 wherein the cap further comprises a removable covering disposed over the plurality of perforations.

24. The system of claim 21 wherein the cap is configured to define an opening via a prescored tab, the opening being configured to allow only a mixture of the monomer and the polymer to pass therethrough.

25. The system of claim 21 wherein the cap comprises a lower cap and an upper cap.

26. The system of claim 25 wherein the lower cap is configured to allow only a mixture of the monomer and the polymer to pass therethrough.

27. A kit for an implantable cement mixture system comprising:
an enclosable container;
a predetermined amount of a polymer;
a predetermined amount of liquid monomer for combination with the polymer into a mixture having a monomer-to-polymer ratio of about 0.3 to about 1 by weight; and
instructions teaching at least:
placing the liquid monomer into the container;
closing the container; and
shaking the container.

28. The kit of claim 27 wherein the kit comprises a cap for the enclosable container.

29. The kit of claim 27 wherein the liquid monomer comprises methyl methacrylate.

30. The kit of claim 27 wherein the polymer comprises a powder selected from the group consisting of polymethyl methacrylate and polymethyl methacrylate/styrene copolymers.

31. The kit of claim 27 further comprising a disassociated agitator configured to fit entirely within the container.

32. The kit of claim 27 wherein the instructions further comprise placing the polymer into the container prior to placing the liquid monomer into the container.

33. The kit of claim 31 wherein placing the liquid monomer into the container further comprises placing the agitator into the container.

34. The kit of claim 27 further comprising a syringe for injecting the liquid monomer into the polymer.

35. The kit of claim 34 wherein the syringe further comprises a needle.

36. The kit of claim 27 wherein the instructions further comprise allowing solvation to occur in the mixture.

37. The kit of claim 36 wherein the instructions further comprise shaking the container following allowing solvation to occur in the mixture.

38. The kit of claim 37 wherein the shaking of the container lasts for at least about 30 seconds.

39. A method of mixing implantable cement comprising:
a) providing a predetermined amount of a monomer and a predetermined amount of a polymer;
b) enclosing the monomer and the polymer in a container such that a mixture having a monomer-to-polymer ratio of about 0.3 to about 1 by weight results; and
c) agitating the mixture in the container.

40. The method of claim 39 further comprising:
d) allowing the mixture to solvate; and
e) agitating the mixture again.

41. The method of claim 39 wherein the monomer comprises liquid methyl methacrylate.

42. The method of claim 39 wherein the polymer is a powder selected from the group consisting of polymethyl methacrylate and polymethyl methacrylate/styrene copolymers.

43. The method of claim 39 wherein the monomer-to-polymer ratio is about 0.53 to about 0.63 by weight.

44. The method of claim 39 wherein the monomer-to-polymer ratio is about 0.57 by weight.

45. The method of claim 39 wherein b) enclosing the monomer and the polymer in a container further comprises enclosing radio-opaque particles in the mixture.

46. The method of claim 45 wherein the radio-opaque particles comprise barium sulfate.

47. The method of claim 39 wherein c) agitating the mixture in the container comprises shaking the container.
